(19) United States
(12) Patent Application Publication
(10) Pub. No.: US 2023/0113654 A1
(43) Pub. Date: Apr. 13, 2023

(54) MANAGING VIRTUAL LOCAL AREA NETWORKS (VLANS) IN MULTIPLE DATA CENTERS

(71) Applicant: WMWARE, INC., Palo Alto, CA (US)

(72) Inventors: RAVI KUMAR REDDY KOTTAPALLI, Bagalore (IN); Shady Ali Ahmed Hamdy Elmalatawey, AlRehab (EG); George Lewis Lotridge, Half Moon Bay, CA (US); Andrew Michael Beltz, Colorado Springs, CA (US); Hari Krishna Meka, Cupertino, CA (US); Shreyash Vinod Nalamwar, Bangalore (IN)

(21) Appl. No.: 17/535,728

(22) Filed: Nov. 26, 2021

(30) Foreign Application Priority Data
Oct. 11, 2021 (IN) 202141046272

(51) Int. Cl. H04L 12/46; H04L 45/44; H04L 45/02

(52) U.S. Cl. CPC H04L 12/4675; H04L 12/4633; H04L 45/02; H04L 45/44

(57) ABSTRACT

Described herein are systems, methods, and software to manage virtual local area network (VLANs) over multiple data centers. In one example, a method of managing a gateway at a first data center includes receiving, at a local manager, configuration information for a VLAN segment and a global VLAN segment identifier from a global manager of the data centers. The method further includes generating a global policy engine (GPE) data structure that associates the global VLAN segment identifier with a virtual network identifier (VNI) for the first data center and one or more policy rules, wherein the policy rules are derived from IP address prefix information provided from a second gateway, such as an edge gateway.

### RELATED APPLICATION

Benefit is claimed under 35 U.S.C. 119(a)-(d) to Foreign Application Serial No. 202141046272 filed in India entitled “MANAGING VIRTUAL LOCAL AREA NETWORKS (VLANS) IN MULTIPLE DATA CENTERS”, on Oct. 11, 2021, by VMware, Inc., which is herein incorporated in its entirety by reference for all purposes.

### BACKGROUND

In computing networks, gateways are used to provide connectivity between different computing sites or data centers. These gateways may be used to implement network address translation, encapsulation, encryption, firewalls, Internet Protocol Security (IPsec) tunneling, or some other operations to connect the different computing sites. The computing elements at each of the computing sites may include physical computing systems, such as desktop computing systems, servers, and the like, and may further include virtual computing systems, such as virtual machines, containers, and the like.

In some implementations, the computing elements at each of the computing systems may be allocated to virtual local area networks (VLANs). A VLAN is a logical network segment which can logically isolate collections of devices on separate physical local area networks (LANs) within a single broadcast domain. For example, virtual machines at a first data center may be allocated to the same VLAN as one or more virtual machines at a second data center, and so a mechanism is needed to enable the machines at each datacenter on a common VLAN to communicate.

### SUMMARY

The technology disclosed herein manages communications for virtual local area networks (VLANs) spanning multiple data centers. In one implementation, a method of managing a distributed gateway at a first data center of a plurality of data centers comprises receiving, at a local manager, configuration information defining a virtual local area network (VLAN) segment from a global manager for the plurality of data centers and receiving a global VLAN segment identifier for the VLAN segment from the global manager. The method further includes generating a global policy engine (GPE) data structure that associates the global VLAN segment identifier with a virtual network identifier (VNI) and updating the GPE data structure with one or more policy rules using prefix information obtained from at least an edge gateway. Once updated, the method includes receiving, at the distributed gateway, a packet from a workload and directing the traffic to the edge gateway based on a policy rule in the GPE data structure, wherein the packet is encapsulated with a VNI based on associations in the GPE data structure.

### BRIEF DESCRIPTION OF THE DRAWINGS

FIG. 1 illustrates a computing environment to manage virtual local area networks (VLANs) across data centers according to an implementation.

FIG. 2 illustrates a method of managing virtual local area networks across multiple data centers according to an implementation.

FIG. 3 illustrates an operational scenario of managing virtual local area networks across multiple data centers according to an implementation.

FIG. 4 illustrates a data structure to manage associations for virtual local area network according to an implementation.

FIG. 5 illustrates a gateway computing system to manage virtual local area networks according to an implementation.

### DETAILED DESCRIPTION

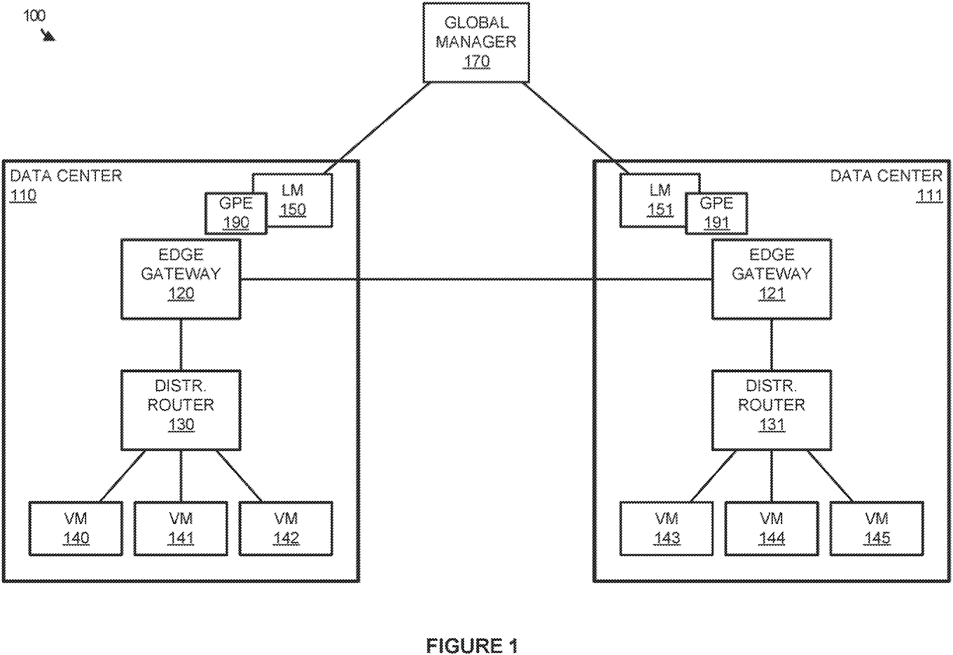

FIG. 1 illustrates a computing environment 100 to manage virtual local area networks (VLAN) across data centers according to an implementation. Computing environment 100 include data centers 110-111. Data centers 110-111 further include edge gateways 120-121, distributed routers 130-131, and virtual machines (VMs) 140-145. VMs 140-145 and distributed routers 130-131 may operate across host computing systems that can provide physical resources, such as processing resources, memory resources, network resources, and other similar resources to the VMs and the distributed routers. Edge gateways 120-121 may comprise physical computing systems capable of networking with other edge gateways and distributed routers 130-131. While virtual machines are shown and described herein throughout, other types of workloads, such as namespace containers, may substituted without significantly impacting the described systems and methods, and with similar beneficial result. A virtual machine is generally understood to include a logical partition of physical computer resources, an operating system, and application software running on that partition, whereas a namespace container, such as a Docker container, also referred to as “operating system-level virtualization,” is an execution space logically partitioned by the operating system running on a physical computer or virtual machine. Furthermore, the term “distributed router” refers to a router having a presence on multiple host computers, for example, as described in U.S. Pat. 9,785,455. However, it should be recognized that any router component intermediate VMs and the edge gateway can perform the described operations and hence, the routers being distributed routers should be understood as an example implementation detail.

In computing environment 100, VMs 140-145 are deployed to provide various operations, wherein the operations may include user desktops, front-end services, database services, data processing services, or some other services. To support the various operations on the virtual machines, logical and physical networking may be used to provide communications between the VMs. The logical and physical networking may be used to provide switching operations, firewall operations, encapsulation operations, or some other operations. In at least one implementation, distributed router 130 may operate on the hosts with VMs 140-142, wherein the distributed router may be used to forward packets to edge gateway 120 to traverse a network, such as the internet. In some implementations, forwarding tables are maintained by the distributed routers to determine whether a packet should be forwarded to edge gateway 120.

Local manager 150 may maintain a global policy engine (GPE) data structure 190 that is used to associate a global VLAN segment identifier with a virtual network identifier (VNI) that can be unique to a data center (local manager 151 may similarly maintain GPE data structure 191 with a possible different association between the VLAN and VNI). Both VLANs and VNIs are logical network segment identifiers comprising a sequence of bits that associate packets to a particular logical network segment. For example, in accordance with the IEEE 802.1 Q standard, VLAN tags (identifiers) are included in an 802.1 Q header between the Layer 2 header and payload. while VNI tags are inserted into a tunnelling protocol header that encapsulates the Layer 2 packet including the Layer 2 header. Thus, while VLAN identifiers associate packets to different VLANs, VNIs associate packets to different overlay networks. The term, “Layer 2” refers to the second layer of the OSI model, which includes the data link-layer, although equivalent layers in other protocol stack models can be substituted.

Global manager 170 can be located at one of data centers 110-111 or at a separate location and may receive a request, e.g., from an administrator, to generate a VLAN that spans multiple data centers. In response to the request, global manager 170 may communicate configuration information about the VLAN segment to local managers 150-151 at each of the data centers. The local manager may be located on one or more of the physical or virtual computing systems of the data centers, including the hosts or edge computing systems. A set of virtual machines, microservice containers, or other endpoint, or combinations thereof, may be attached to a particular VLAN having a VLAN identifier. Packets in a particular VLAN are tagged with the VLAN identifier for the VLAN associated with the set of endpoints.

For example, a packet from virtual machine 140 may include the global VLAN identifier. Once received at distributed router 130, distributed router 130 may identify the global VLAN identifier in the packet and map the global VLAN identifier to a VNI based on configurations provided in a forwarding table by the local manager. In some implementations, the table may be populated based on exchanged information between gateways or between the distributed router and the edge gateway. The exchanged information may include prefix advertisement from upstream gateways to direct packets toward the corresponding gateway. For example, edge gateway 120 may advertise one or more prefixes to distributed router 130. Based on the advertising, the GPE data structure can be updated to include the addresses directing VLAN packets with corresponding destination IP addresses to edge gateway 120, wherein the packets are encapsulated with the VNI associated with global VLAN identifier.

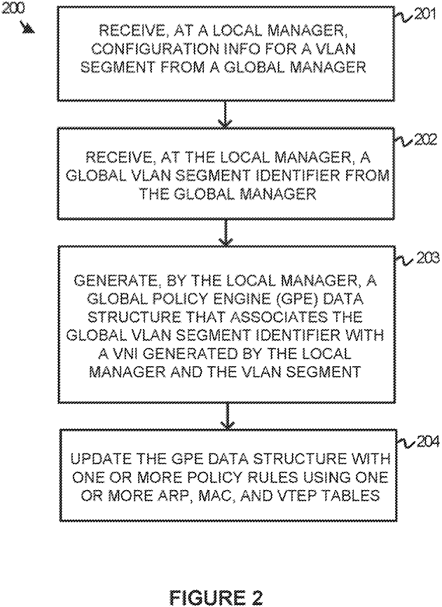

FIG. 2 illustrates a method 200 of managing virtual local area networks across multiple data centers according to an implementation. The steps of method 200 are referenced parenthetically in the paragraphs that follow with reference to systems and elements of computing environment 100 of FIG. 1. The specific example provided below is described as configuring a gateway in data center 110, however, similar operations may be applied to configure a gateway in another data center.

Method 200 includes receiving (201), at a local manager for a data center, configuration information defining a VLAN segment from a global manager for the plurality of data centers. The configuration information for the VLAN segment is used to define the addresses and workloads that will correspond to a particular VLAN. In addition, method 200 includes receiving, at the local manager, (202) a global VLAN segment identifier for the VLAN segment from the global manager. This global VLAN segment identifier is used to uniquely identify the VLAN in relation to other VLANs also configured within the same computing environment. For example, a first VLAN with VMs 140-141 and VM 143 may be allocated a first global VLAN segment identifier, while VM 142 and VMs 144-145 are allocated a second global VLAN segment identifier. In at least one implementation, the global manager may assign the unique global VLAN segment identifier to a set of endpoints in response to a request for configuring the VLAN segment and may distribute the segment identifier with the configuration information to local managers at each of the data centers supporting the VLAN segment.

Once the information is received in association with the global VLAN segment identifier, method 200 further includes generating (203), in the local manager, a GPE data structure that associates the global VLAN segment identifier with a virtual network identifier (VNI). The VNI may be used to uniquely identify packets within the datacenter that correspond to the global VLAN. Specifically, while the global VLAN segment identifier may be used to uniquely identify the VLAN in relation to other VLANs in the computing environment, a local manager at each of the data centers may allocate a VNI to the VLAN segment for use in association with the VLAN segment. The VNI corresponds to a particular overlay network, while the VLAN segment identifier is used in the underlay header for packets in the VLAN segment, by associating the VNI to the global VLAN, the local manager in essence creates an overlay network exclusively for the VLAN so that the edge gateway can, using the VNI, forward the VLAN packets to a remote datacenters as needed. For example, when distributed router 130 receives a packet from a VM 140 that is directed to another VM 143 that is part of the same VLAN segment but on a different physical network, distributed router 130 may translate the VLAN to a VNI and use the VNI to encapsulate and forward the packet toward edge gateway 120. The encapsulation may comprise Generic Network Virtualization Encapsulation (Geneve) encapsulation, VXLAN, or some other encapsulation protocol, wherein the VNI may be placed in the header of the encapsulated packet to indicate the associated VLAN. The VNI is only used when the packet comprises a VLAN packet, distributed router 130 may also encapsulate other packets and forward the packets to the edge as required without including a VNI in the header of the packet.

In addition to associating the global VLAN segment identifier with the VNI for the individual data center, method 200 further provides for updating (204) the GPE data structure with one or more policy rules using prefix information obtained from at least one edge gateway. Referring to the example above, when VM 140 communicates a packet to VM 143, the packet may be directed to distributed router 130 based on flow rules maintained by the host (not shown) for virtual machine 140. Distributed router 130 may access the GPE data structure, which is made accessible by local manager 130, to determine whether the addressing in the packet matches a policy rule and, if the packet matches a policy rule, may encapsulate the packet, and forward the packet toward edge gateway 120. In some examples, at least a portion of the GPE data structure is distributed to the computing systems providing distributed router 130, but the GPE data structure may also be maintained and accessed from a centralized location in some examples. In some implementations, distributed router 130 may obtain prefix information from edge gateway 120, indicating prefixes that are available over edge gateway 120. These prefixes are then used to generate policy rules in the GPE data structure to define how packets associated with various VLANs are forwarded. For example, edge gateway 120 may indicate that a prefix associated with VM 143 is located behind a remote tunnel endpoint (RTEP) provided by edge gateway 120. As a result, distributed router 130 may encapsulate the packet and forward the packet to edge gateway 120, wherein the encapsulation will include the VNI associated with the global VLAN from the GPE data structure.

Once the packet is received by edge gateway 120, edge gateway 120 may decapsulate the packet and determine a destination edge based on the addressing of the packet. Here, because the destination IP address for the packet corresponds to VM 143 at data center 111, edge gateway 120 may encapsulate the packet for a second time and forward the packet to edge gateway 121. Edge gateway 121 may be determined as the destination based on the exchange of prefix information between the data centers. After receiving the packet, edge gateway 121 may decapsulate the packet, determine a destination for the packet and forward the packet toward the destination VM 143. In forwarding the packet, the packet may be encapsulated by gateway 121 and forwarded to the distributed router 131, wherein distributed router 131 may execute on the same host as VM 143. The packet may then be provided to VM 143 as a VLAN packet. Advantageously, although VMs 140 and 143 are in separate data centers, the distributed routers and edge gateways may process a VLAN packet and forward the VLAN packet is required using multiple forms of encapsulation.

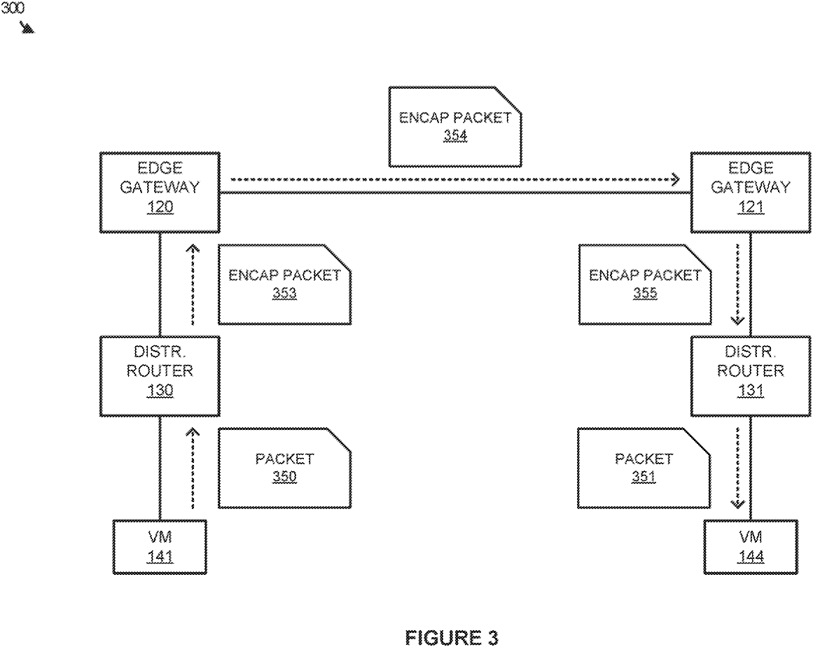

FIG. 3 illustrates an operational scenario 300 of managing virtual local area networks across multiple data centers according to an implementation. Operational scenario 300 includes VMs 141 and 144, distributed routers 130-131, and edge gateways 120-121 from computing environment 100 of FIG. 1. Operational scenario 300 further includes packets 350-351 and encapsulated packets 353-355.

A global manager may be used to configure a VLAN across multiple data centers, wherein the global manager may be located at one of the data centers or may be in a remote computing location. In response to a request to configure a VLAN segment, the global manager will distribute configuration information about the VLAN segment to local managers for the data centers. The information may indicate virtual machines associated with a VLAN, a global VLAN segment identifier that can be used to identify the VLAN packets across all the data centers, or some other information. Once the information about the VLAN is obtained, the local manager at the data center may generate a GPE data structure that associates the global VLAN segment identifier with a virtual network identifier (VNI), wherein the VNI may be used in overlay packets at the data center to identify packets associated with the VLAN. A VNI may comprise a uniquely selected number that can be included in the header for an overlay packet to identify packets in associated with the VLAN at the encapsulation level. The VNI value may be selected pseudo-randomly, selected from a pool of available VNIs, or selected in some other manner.

In addition to associating the global VLAN segment identifier with the VNI value for the GPE data structure, the GPE data structure may also be updated based on prefix information supplied in association with edge gateway 120. In some implementations, edge gateway 120 may obtain and forward information about prefixes available at data center 111. The prefix information may be used to generate policy rules for the created VLAN, wherein packets with destination addresses at data center 111 are directed to edge gateway 120. These packets may be encapsulated using Geneve (or VXLAN in some examples), wherein the encapsulated packet may indicate the VNI associated with the VLAN packet.

Here, packet 350 is communicated from VM 141 that is destined for VM 144 at the second data center or computing site, wherein VMs 141 and 144 are belong to the same VLAN segment. Packet 350 originates from an endpoint assigned to a global VLAN and is accordingly tagged with a VLAN identifier. The VLAN identifier may be added to the packet by the endpoint itself, or by an intermediary, such as a virtual switch provided by a host on which the endpoint is instantiated. The virtual switch connects the endpoint to the physical network and may be configured to tag packets received from the source endpoint with the global VLAN identifier. The packet is forwarded to distributed router 130 based on flow rules applied to IP addressing in the packet on the host for VM 141. For example, the flow rules may compare destination IP addressing of the packet to determine how the packet should be forwarded. Once received by distributed router 130, distributed router 130 may apply a policy defined by the GPE data structure to the packet to determine how the packet is forwarded. In some implementations, distributed router 130 may be employed at least partially on the same host as VM 141. Based on the policy rules maintained in the GPE data structure, distributed router 130 may encapsulate the packet using Geneve, VXLAN, or some other encapsulation/tunneling protocol, and in so doing insert the VNI into the encapsulated packet. The VNI is determined by the identified policy rule which maps the VLAN identifier in the packet to the specific VNI. Once encapsulated, distributed router 130 may forward the encapsulated packet 353 to edge gateway 120.

In some implementations, any edge gateways coupled to distributed router 130 may report the IP prefix information for destination virtual machines. Thus, although a single edge gateway is demonstrated in computing environment 100 for data center 110, multiple edge gateways may be included that could link to other data centers. Each of the edge gateways may advertise to distributed router 130 the available destination IP address prefixes, such that packets with the prefixes are forwarded to the corresponding edge gateway. Accordingly, packets with first addressing attributes may be forwarded to a first edge gateway, while packets with second addressing attributes are forwarded to a second edge gateway.

Once encapsulated packet 353 is received by edge gateway 120, edge gateway 120 may decapsulate the packet and process addressing attributes in the packet to determine forwarding actions associated with the packet. The processing operations at edge gateway 120 may further include firewall operations, network address translation operations, or other operations in association with the packet. In at least one implementation, edge gateway 120 may identify the destination IP address in the decapsulated packet and compare the destination address to one or more flow tables to determine a forwarding path for the packet. Here, the destination IP address corresponds to VM 144, whose prefix information may be advertised by edge gateway 121. Accordingly, the packet may be re-encapsulated as encapsulated packet 354 and communicated to edge gateway 121. The encapsulation may comprise Geneve or VXLAN encapsulation in some examples. The encapsulation may also use a separate VNI in some examples, that is used as a network identifier between edge gateway 120 and edge gateway 121. In some implementations, encapsulated packet 354 may comprise an IPsec packet, although other encapsulation protocols may be used.

After encapsulated packet 354 is received by edge gateway 121, edge gateway 121 may decapsulate the packet and process the packet. In some implementations, edge gateway 121 may identify addressing information in the decapsulated packet and determine how to forward the packet based on the addressing information. Here, edge gateway 121 identifies destination addressing in the decapsulated packet and uses the destination addressing to select distributed router 131 for the packet. Once selected, the packet is encapsulated as encapsulated packet 355 and forwarded to distributed router 131, wherein distributed router 131 may operate on the same host as VM 144 in some examples. Encapsulated packet 355 may include a VNI in the header that corresponds to the VLAN for the packet, which can be determined via the association in GEP data structure 191. Encapsulated packet 355 is received by distributed router 131, decapsulated, and forwarded to VM 144 as packet 351, applying to flow rules based on the destination IP address in the packet. Packet 351 may include the same global VLAN segment identifier as the original packet 141.

In some implementations, the GPE data structure maintained for distributed router 130 may be updated as changes are made in association with the VLANs of the computing environment. The changes to the GPE data structure may be determined based on the global manager providing information about new VLAN configurations, based on the global manager changing a configuration of a current VLAN segment, based on migrations and changes identified in the IP prefixes advertised to distributed router 130, or may be modified in some other manner. For example, if the global manager removes a VLAN segment, the GPE data structure may be updated to remove the global identifier and any associations with the global identifier.

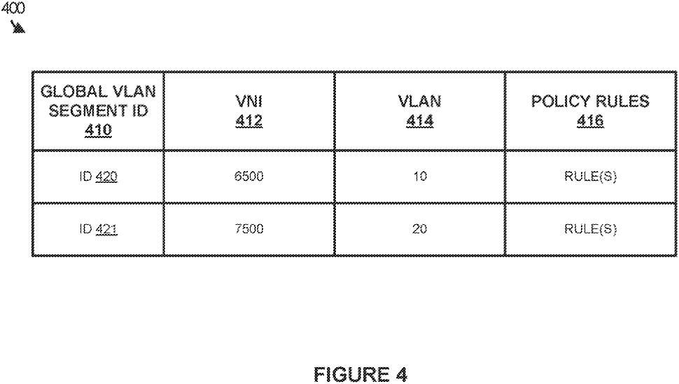

FIG. 4 illustrates a data structure 400 to manage associations for virtual local area network according to an implementation. Data structure 400 is representative of a GPE data structure that is maintained by a local manager to direct packets associated with VLAN segments. Data structure 400 includes columns for global VLAN segment identifier (ID) 410, VNI 412, VLAN 414, and policy rules 416. Other columns or information may be stored in the data structure in some examples, including route-map information, policy-map identifiers, or some other information.

In one implementation, a global manager may identify a request to configurate a VLAN segment and distribute configuration information about the segment to local managers at the various data centers supporting the VLAN segment. The configuration information may identify the global VLAN segment identifier that is used to distinguish the VLAN segment from other segments, may indicate virtual machines or virtual machine addresses associated with the VLAN segment, or may include some other information related to the VLAN. For example, a segment may be configured that corresponds ID 420. In response to the segment being added, a VNI is generated in association with the VLAN segment, and policy rules are determined that dictate how packets are forwarded in association with the VLAN segment. In determining the policy rules, an upstream gateway or edge gateway may provide IP prefix information associated with the edge gateway. The IP address information may indicate the availability of workloads via the edge gateway, wherein the edge gateway may connect to at least one other data center using the internet.

In some implementations, when a VLAN packet is received at a distributed router, the addressing information in the packet may be processed to determine how the packet should be forwarded. The IP addressing information can be compared to the policy rules in data structure 400 to identify a matching rule for the packet. Once a rule is identified, the distributed router may encapsulate the packet using the corresponding VNI for the policy rule (matching the VLAN) and forward the encapsulated packet to the second gateway (edge gateway). In some implementations, the packet may be encapsulated using Geneve or some other encapsulation protocol. In some examples, the distributed router may operate as part of a host computing system with the workload, while the second edge gateway may comprise a separate computing system capable of communicating packets over an external network (i.e., the internet).

Once the packet is encapsulated and communicated to the second gateway, the second gateway may process the packet and forward the packet to a second data center. In some examples, the second gateway may decapsulate the packet, determine forwarding actions based on the decapsulated packet, re-encapsulate the packet, and forward the packet to a second data center. In some implementations, the second gateway may use the VNI information to determine a VLAN segment associated with the inner packet. In some examples, the second encapsulation of the packet may use a different VNI than the first encapsulation.

In some examples, the information in data structure 400 may be updated at various intervals based on changes to the computing environment. The changes may include the addition or deletion of VLAN segments, changes in deployment locations of the workloads, or some other changes. For example, when virtual machines are deployed in a data center, an edge for the data center may advertise addressing information for the virtual machines to other connected data centers using border gateway protocol (BGP), address resolution protocol (ARP), or some other advertising protocol. Based on the advertising, the information in data structure 400 may be updated to reflect policy rules for the advertised addresses. Thus, if a second data center advertised a prefix corresponding to a unique VLAN identifier, data structure 400 may be updated to direct packets toward the second data center using the corresponding edge.

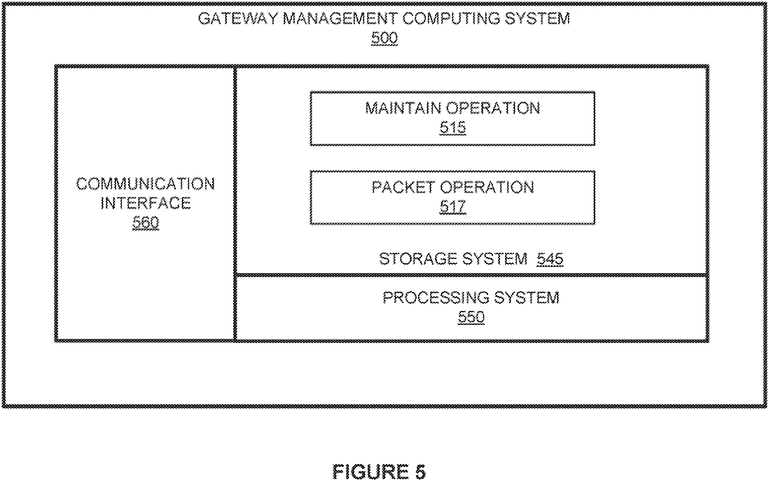

FIG. 5 illustrates a gateway computing system 500 to manage VLANs according to an implementation. Computing system 500 is representative of any computing system or systems with which the various operational architectures, processes, scenarios, and sequences disclosed herein for a local manager for a gateway can be implemented. Computing system 500 is an example of local manager 150 of FIG. 1, although other examples may exist. Computing system 500 includes storage system 545, processing system 550, and communication interface 560. Processing system 550 is operatively linked to communication interface 560 and storage system 545. Computing system 500 may further include other components such as a battery and enclosure that are not shown for clarity.

Communication interface 560 comprises components that communicate over communication links, such as network cards, ports, radio frequency (RF), processing circuitry and software, or some other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format - including combinations thereof. Communication interface 560 may be configured to communicate with one or more gateway gateways and may further communicate with one or more computing elements, such as host computing systems, desktop computing systems, or some other computing system. Communication interface 560 may be configured to receive VLAN segment configuration information from global manager in some examples.

Processing system 550 comprises microprocessor and other circuitry that retrieves and executes operating software from storage system 545. Storage system 545 may include volatile and nonvolatile, removable and non-removable media implemented in any method or technology for storage of information, such as computer readable instructions, data structures, program modules, or other data. Storage system 545 may be implemented as a single storage device but may also be implemented across multiple storage devices or sub-systems. Storage system 545 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 550 is typically mounted on a circuit board that may also hold the storage system. The operating software of storage systems 545 comprises computer programs, firmware, or some other form of machine-readable program instructions. The operating software of storage system 545 comprises maintain operation 515 and packet operation 517. The operating software on storage system 545 may further include utilities, drivers, network interfaces, applications, or some other type of software. When read and executed by processing system 550 the operating software on storage system 545 directs computing system 500 to operate as described herein. In some implementations, maintain operation 515 may provide at least method 200 described in FIG. 2.

In at least one implementation, maintain operation 515 directs processing system 550 to maintain a GPE data structure that associates global VLAN segment identifiers with a corresponding VNI and one or more policy rules. In maintaining the GPE data structure, maintain operation 515 may receive, as a local manager, configuration information for a VLAN segment and a global VLAN segment identifier for the segment from a global manager. Once received, maintain operation 515 may store the global VLAN segment identifier in the GPE data structure and associate the global VLAN segment identifier with a VNI generated locally by the local manager at the data center and policy rules for the VLAN. In at least one implementation, the policy rules may be learned via exchanges between the gateway upstream routers, such as edge gateways, or other networking elements that can provide next-hop prefix operations. In at least one implementation, the information may be exchanged between gateways (edge and distributed) and the local manager may update the data structure based on the exchanged prefix information. The local manager may add one or more policy rules that are used to direct packets to gateways associated with a desired destination address. For example, the policy rules may be used to direct packets to an edge gateway based on the destination address in the packet. When a packet is received from a workload (e.g., a virtual machine), the distributed router may process the packet to identify addressing information in the packet and forward the packet based on the policy rules in the GPE data structure.

As the GPE data structure is maintained, packet operation 517 directs processing system 550 receive a packet from a workload and determine that addressing information in the packet matches a policy rule in the GPE data structure. In some implementations, the entries in the data structure may indicate a next-hop or tunnel for the packet to be communicated. In at least one example, packet operation 517 may identify a destination IP address in the packet and identify a VNI associated with the destination IP address and the VLAN identifier in the packet. Once the VNIC is identified, packet operation 517 directs processing system 550 to encapsulate the packet with an associated VNI for the policy rule and forward the encapsulated packet to the second gateway (i.e., the edge gateway for the data center).

In some examples, the destination IP address and/or VLAN identifier may be identified in the packet and compared to the policy rules to identify a matching entry. The matching entry may indicate the VNI associated with the destination address, an edge associated with the destination address, or some other information associated with forwarding the packet toward the destination workload. For example, the policy rule may indicate that the packet should be forwarded to a first edge gateway with a first VNI in the header of the encapsulated packet, wherein the VNI can be used to identify the VLAN segment associated with the packet. The encapsulation may comprise Geneve encapsulation, VXLAN encapsulation, or some other encapsulation.

Once the encapsulated packet is received by the edge gateway, the edge gateway may decapsulate the packet and process the packet to determine one or more forwarding rules associated with the packet. In some implementations, the edge gateway may process the destination address in the decapsulated packet to determine forwarding actions associated with the packet or may use the VNI to determine how to forward the packet. In some examples, the edge gateway may use a data structure or table that can be used to direct packets to a gateway at a second data center or computing site. This table may indicate a different VNI for the tunnel, a destination IP address associated with the tunnel to the second data center, or some other information. Once processed by the second gateway, the packet can be encapsulated and forwarded to a gateway at the second data center or computing site.

The gateway at the second data center may decapsulate the packet and process the packet to forward the packet to the destination workload. The processing of the packet may include identifying addressing attributes associated with the packet, identifying forwarding rules based on one or more data structures, and forwarding the packet toward the destination workload. In some examples, the forwarding of the packet may include decapsulating the packet at an edge of the second data center, re-encapsulating the packet, and forwarding the re-encapsulated packet to a distributed router associated with the destination workload. Once received by the distributed router, the packet may be decapsulated and forwarded to the destination workload as a VLAN packet.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of managing a distributed router at a first data center of a plurality of data centers, the method comprising:
receiving, at a local manager for the distributed router, configuration information for a virtual local area network (VLAN) segment from a global manager for the plurality of data centers, wherein the configuration information indicates at least workloads that belong to the VLAN;
receiving, at the local manager, a global VLAN segment identifier for the VLAN segment from the global manager;
generating, by the local manager, a global policy engine (GPE) data structure that associates the global VLAN segment identifier with a virtual network identifier (VNI);
updating the GPE data structure with one or more policy rules using prefix information obtained from one or more edge gateways.
in the distributed router, receiving a packet from a workload of the workloads;
in the distributed router, determining that addressing of the packet matches a policy rule in the GPE data structure;
in the distributed router, identifying a VNI for the packet based on the GPE data structure;
in the distributed router, encapsulating the packet with the VNI; and
in the distributed router, forwarding the encapsulated packet to an edge gateway of the one or more edge gateways.

2. The method of claim 1, wherein the encapsulated packet comprises a Generic Network Virtualization Encapsulation (Geneve) encapsulated packet.

3. The method of claim 1, wherein the distributed router operates on one or more host computing systems.

4. The method of claim 1, wherein the method further comprises, in the edge gateway:
receiving the encapsulated packet;
decapsulating the encapsulated packet;
identifying a second edge gateway at a second computing site for the packet;
re-encapsulating the packet; and
forwarding the re-encapsulated packet to the second edge gateway.

5. The method of claim 4, wherein the re-encapsulating the packet comprises re-encapsulating the packet as an IPsec packet.

6. The method of claim 1 further comprising, in the local manager, generating the VNI in association with the global VLAN segment identifier.

7. The method of claim 1, wherein the workload comprises a virtual machine.

8. The method of claim 1, wherein encapsulating the packet with the VNI comprises encapsulating the VNI in the header of the encapsulated packet.

9. A computing apparatus comprising:
a storage system;
a processing system operatively coupled to the storage system; and
program instructions stored on the storage system to manage a gateway at a first data center of a plurality of data centers that, when executed by the processing system, direct the computing apparatus to:
receive, at a local manager for the distributed router, configuration information for a virtual local area network (VLAN) segment from a global manager for the plurality of data centers, wherein the configuration information indicates at least workloads that belong to the VLAN;
receive, at the local manager, a global VLAN segment identifier for the VLAN segment from the global manager;
generate, by the local manager, a global policy engine (GPE) data structure that associates the global VLAN segment identifier with a virtual network identifier (VNI);
update the GPE data structure with one or more policy rules using prefix information obtained from one or more edge gateways.
in the distributed router, receive a packet from a workload of the workloads;
in the distributed router, determine that addressing of the packet matches a policy rule in the GPE data structure;
in the distributed router, identify a VNI for the packet based on the GPE data structure;
in the distributed router, encapsulate the packet with the VNI; and
in the distributed router, forward the encapsulated packet to an edge gateway of the one or more edge gateways.

10. The computing apparatus of claim 9, wherein the encapsulated packet comprises a Generic Network Virtualization Encapsulation (Geneve) encapsulated packet.

11. The computing apparatus of claim 9, wherein the distributed router operates on one or more host computing systems.

12. The computing apparatus of claim 9, wherein the method further comprises, in the edge gateway:
receive the encapsulated packet;
decapsulate the encapsulated packet;
identify a second edge gateway at a second computing site for the packet;
re-encapsulate the packet; and
forward the re-encapsulated packet to the second edge gateway.

13. The computing apparatus of claim 12, wherein the re-encapsulating the packet comprises re-encapsulating the packet as an IPsec packet.

14. The computing apparatus of claim 9, in the local manager, generating the VNI in association with the global VLAN segment identifier.

15. The computing apparatus of claim 9, wherein the workload comprises a virtual machine.

16. The computing apparatus of claim 9, wherein encapsulating the packet with the VNI comprises encapsulating the VNI in the header of the encapsulated packet.

17. A system comprising:
a distributed router;
an edge gateway; and
a local manager configured to:
maintain, for the distributed router, a GPE data structure that associates global VLAN segment identifiers provided by a global manager each with a corresponding virtual network identifier (VNI) and one or more policy rules;
the distributed router configured to:
receive a packet from a workload;
determine that addressing of the packet matches a policy rule in the GPE data structure;
encapsulate the packet with an associated VNI for the policy rule; and
forward the encapsulated packet to the second gateway.

18. The system of claim 17, wherein maintaining the GPE data structure comprises:
receiving IP address prefix information from the second gateway; and
updating the GPE data structure with the one or more policy rules based on the IP address prefix information.

19. The system of claim 17, wherein encapsulated packet comprises a Generic Network Virtualization Encapsulation (Geneve) encapsulated packet.

20. The system of claim 17, wherein the workload comprises a virtual machine.
